(19) United States
(12) Patent Application Publication
(10) Pub. No.: US 2006/0129485 A1
(43) Pub. Date: Jun. 15, 2006

(54) Business method for credit card verification

(75) Inventors: Mark Joseph Hamzy, Round Rock, TX (US); Dustin C. Kirkland, Austin, TX (US); Edward Scott Rozmiarek, Round Rock, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 11/011,249

(22) Filed: Dec. 14, 2004

(51) Int. Cl. G06Q 40/00

(52) U.S. Cl. 705/40

(57) ABSTRACT

A means by which possession of a credit card can be validated in transactions over the Internet is presented. As part of the payment transaction, a vendor instructs the user to use an electronic camera to take a picture of the credit card in a specific situation, such as being held in the user's hand or held against a generated computer screen. The resulting picture is emailed to the vendor, who forwards the image to the credit card company for verification.

### BACKGROUND OF THE INVENTION

1. Technical Field

The present invention is generally directed toward the verification of a credit card. More specifically, the invention is directed toward the verification of a credit card that is being used in an Internet application.

2. Description of Related Art

The Internet has become a cultural fixture as a source of both information and entertainment. Many businesses are creating Internet sites as an integral part of their marketing efforts, informing consumers of the products or services offered by the business or providing other information seeking to engender brand loyalty. Many federal, state, and local government agencies are also employing Internet sites for informational purposes, particularly agencies that must interact with virtually all segments of society such as the Internal Revenue Service and secretaries of state. Further, the Internet is becoming increasingly popular as a medium for commercial transactions.

When commercial transactions are performed on the Internet, credit cards are used extensively, even more heavily than in face-to-face commerce. While this capability is a logical extension of the use of credit cards, it presents additional problems in terms of ensuring that the person presenting the credit card is authorized to charge to the card. Credit card companies have evolved a number of strategies to manage the verification process when the credit card is presented in person. It is known that the company issuing the credit card will charge a fee to the business that receives the card in payment. The credit card company can offer discounts on this fee if the business will go through a verification process before finalizing a sale. This generally involves a telephone call to the issuing company, where the credit card number can be checked to ensure that, at the least, (a) the card not been reported stolen, (b) the associated account is current, with no outstanding overdue payments, (c) the account balance does not exceed the pre-determined limit for this customer, and possibly (d) the current transaction is not wildly out of line for this account, e.g. is not for an amount or coming from a location that would appear suspicious to someone with some knowledge of the customer. To ensure that the card is physically presented by the user, the credit card company can also request additional information, such as the expiration date of the card or the value of a code printed on the backside of the credit card.

When a customer orders over the Internet, it is impossible for the entity managing the financial side of the transaction to physically examine the credit card or to know that the card is actually in the possession of the presenting person. This leaves a window open for the fraudulent use of the credit card.

### SUMMARY OF THE INVENTION

The present invention provides a method, apparatus, and computer instructions for validating possession of a credit card or other type of transaction card in transactions over the Internet. As part of the payment transaction, the vendor instructs the user to use an electronic camera to take a picture of the credit card in a specific situation, such as being held in the user's hand. The resulting picture is emailed to the vendor, who forwards the image to the credit card company, or other transaction entity, for verification.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of the Internet and associated connections in which the present invention may be implemented.

FIG. 2 depicts a block diagram of a data processing system that may be implemented as a server, such as a server for the vendor or credit-card company in FIG. 1.

FIG. 3 depicts a data processing system, such as a computer for the client of FIG. 1, in which the present invention can be initiated.

FIGS. 4A and 4B depict possible relationships between the three entities involved in an online purchase using a credit card.

FIG. 5 discloses a flowchart of the process of verifying a user's credit card over the Internet.

FIG. 6 discloses a photograph of a credit card being held by a user, according to an embodiment of the invention.

FIG. 7 discloses a website designed to ensure that a picture, such as the photograph shown in FIG. 5, is a current photo, according to an embodiment of the invention.

### DETAILED DESCRIPTION OF THE PREFERRED EMBODIMENT

In the past decade or so, the availability of digital cameras and their subsequent inclusion in cell phones has made it not only possible, but easy to send photos from one location to another. The invention disclosed herein is one of the many ways in which this ability can be leveraged to serve new purposes. It is noted here that although the specification refers repeatedly to a credit card, the invention is also applicable to debit cards, vouchers, coupons, tickets, passes such as season passes, etc. These can collectively be referred to as “transaction cards”, while the credit card company, bank, or other authorizing entity can be collectively referred to as the “transaction entity”.

Currently, the most commonly employed method of transferring data over the Internet is to employ the World Wide Web environment, also called simply “the Web”. Other Internet resources exist for transferring information, such as File Transfer Protocol (FTP) and Gopher, but have not achieved the popularity of the Web. In the Web environment, servers and clients effect data transaction using the Hypertext Transfer Protocol (HTTP), a known protocol for handling the transfer of various data files (e.g., text, still graphic images, audio, motion video, etc.). The information in various data files is formatted for presentation to a user by a standard page description language, the Hypertext Markup Language (HTML). In addition to basic presentation formatting, HTML allows developers to specify “links” to other Web resources identified by a Uniform Resource Locator (URL). A URL is a special syntax identifier defining a communications path to specific information. Each logical block of information accessible to a client, called a “page” or a “Web page”, is identified by a URL. The URL provides a universal, consistent method for finding and accessing this information, not necessarily for the user, but mostly for the user's Web “browser”. A browser is a program capable of submitting a request for information identified by an identifier, such as, for example, a URL. A user may enter a domain name through a graphical user interface (GUI) for the browser to access a source of content. The domain name is automatically converted to the Internet Protocol (IP) address by a domain name system (DNS), which is a service that translates the symbolic name entered by the user into an IP address by looking up the domain name in a database.

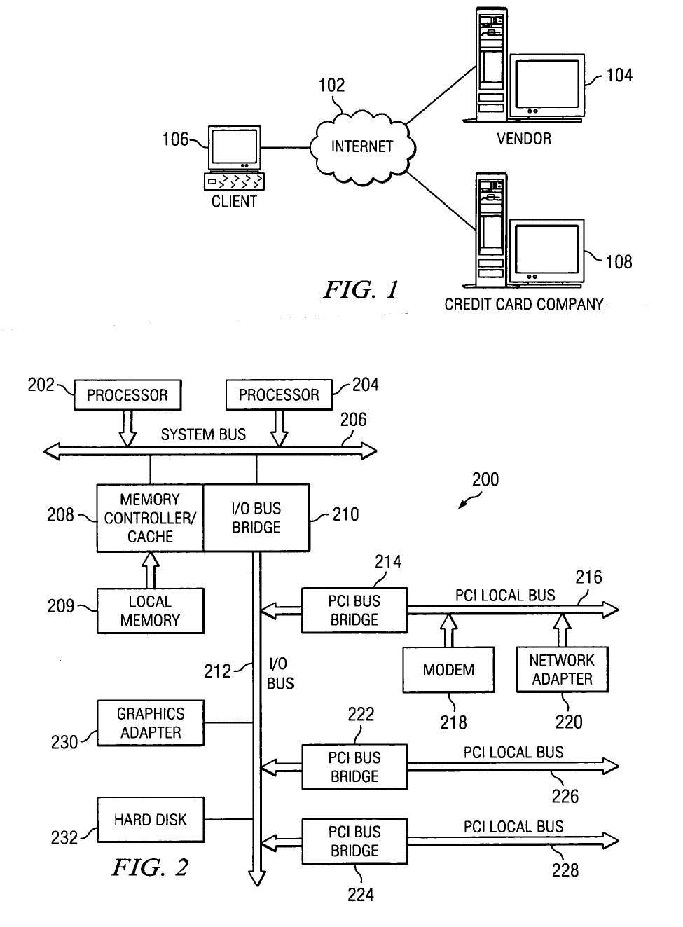

With reference now to the figures, FIG. 1 depicts a pictorial representation of a network of data processing systems, such as the Internet, in which the present invention may be implemented. Internet 102 is the medium used to provide communications links between various devices and computers connected together for mutual communications and commerce. Internet 102 may include connections, such as wire, wireless communication links, or fiber optic cables.

In the depicted example, vendor 104 and credit card company 108 are both connected to Internet 102. In addition, users, such as clients 106, are connected to Internet 102. Client 106 may be, for example, a personal computer or a network computer. In the depicted example, vendor 104 is a business that provides goods or services to clients, such as client 106, and receives payment, using Internet 102. Payment can be received using a credit card, debit card, a draw against a checking account, or using an intermediary, although the present application is directed to the use of credit cards and/or debit cards. Reference throughout this specification is to a credit-card company, but it will be understood by one of ordinary skill in the art that a debit card can also be used, with the banking institution that issues the debit card standing in the place of the credit-card company. Credit-card company 108 provides unsecured loans to customers through the use of credit cards. Internet connections will, of course, include numerous additional servers, clients, and other devices not shown. In the depicted example, Internet 102 represents a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. FIG. 1 is intended as an example, and not as an architectural limitation for the present invention.

Referring to FIG. 2, a block diagram of a data processing system that may be implemented as a server, such as a server for vendor 104 or credit-card company 108 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O Bus Bridge 210 is connected to system bus 206 and provides an interface to I/O bus 212. Memory controller/cache 208 and I/O Bus Bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pseries system, a product of International Business Machines Corporation in Armonk, N.Y., running the Advanced Interactive Executive (AIX) operating system or LINUX operating system.

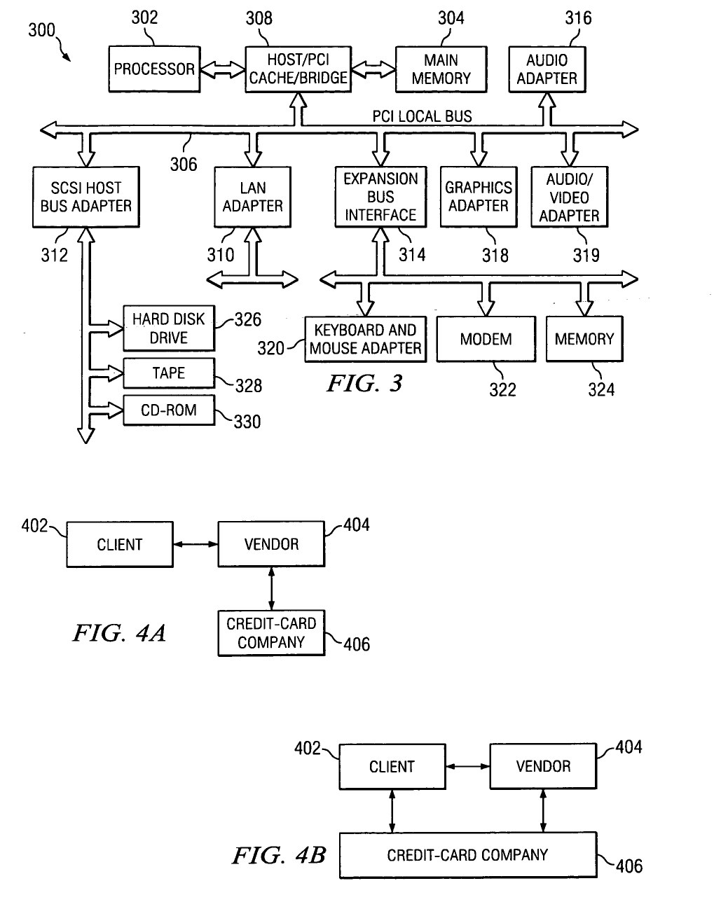

With reference now to FIG. 3, a block diagram illustrating a data processing system is depicted in which the present invention may be implemented. Data processing system 300 is an example of a client computer, such as client 106. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI Bridge 308. PCI Bridge 308 also may include an integrated memory controller and cache memory for processor 302. Additional connections to PCI local bus 306 may be made through direct component interconnection or through add-in boards. In the depicted example, local area network (LAN) adapter 310, small computer system interface (SCSI) host bus adapter 312, and expansion bus interface 314 are connected to PCI local bus 306 by direct component connection. In contrast, audio adapter 316, graphics adapter 318, and camera-card adapter 319 are connected to PCI local bus 306 by add-in boards inserted into expansion slots. Expansion bus interface 314 provides a connection for a keyboard and mouse adapter 320, modem 322, and additional memory 324. SCSI host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented programming system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interfaces As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

FIGS. 4A and 4B depict possible relationships between the three entities involved in an online purchase using a credit card. In FIG. 4A, client 402 typically carries on a dialog with vendor 404 through a website, e.g., browsing a catalog and placing an order and submitting payment, such as a credit card number. In the embodiment shown, vendor 404 would receive the credit card information, including a requested photograph of the credit card, which is then relayed to credit-card company 406 upon receipt of this information. Vendor 404 can request that client 402 enters the credit card information separately, with a photograph used only for purposes of a discount. Alternatively, the vendor can rely completely on a photograph to provide all desired information. Preferably any credit card information is encrypted, both for transmission over the Internet and so that employees of vendor 404 cannot snoop transactions. Credit-card company 406 then performs any tests it desires to verify the authenticity of the depicted credit card and returns two decisions. The first decision in this illustrative example is simply whether the credit card is accepted or declined. Cards may be declined when the user is over a balance limit or a timely payment has not been received. The second decision is whether the photograph submitted is considered valid and current, so that a discount is offered to vendor 404. Vendor 404 can then pass on this information to client 402 and conclude the transaction.

An alternate embodiment is depicted in FIG. 4B, in which client 402 has direct communications with both vendor 404 and with credit-card company 406. Client 402 interfaces with vendor 404 for a purchase, establishing, for example, a unique transaction identifier. Client 402 then carries on a dialog with credit-card company 406 to validate a current credit limit and possession of the credit card, passing the transaction identifier to credit-card company 406.

On validation of the credit card, company 406 sends an acknowledgement of the user's validity, containing information that a discount is given, and passing on the transaction identifier. In this manner, the vendor receives payment without ever having the credit card information pass through their hands.

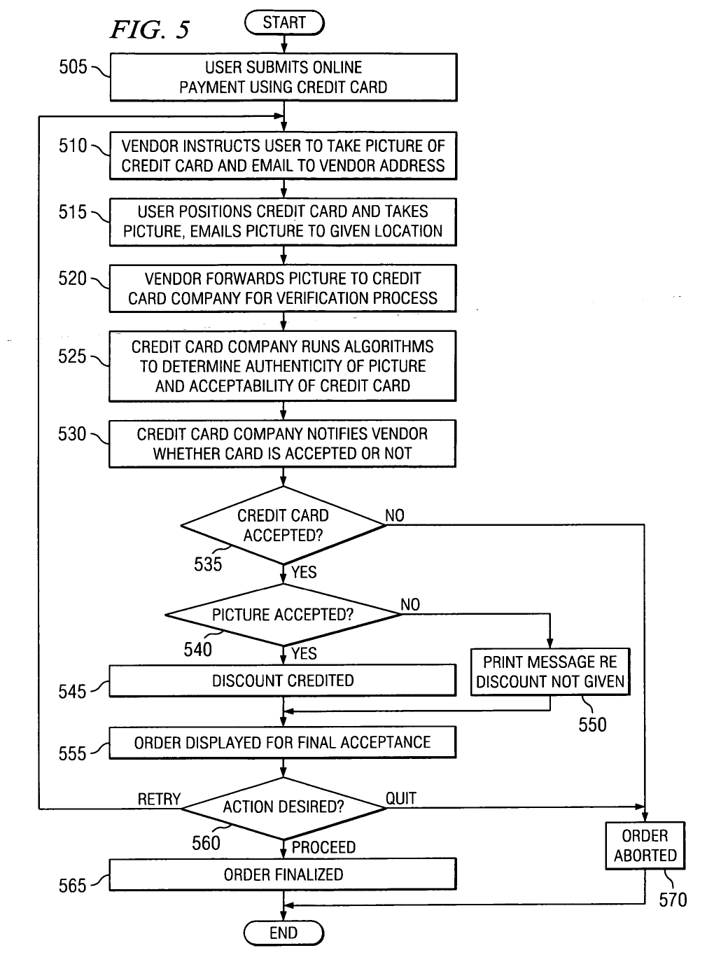

The illustrative steps of the present invention will now be discussed with reference to FIG. 5, which shows a flowchart of the process. A user employs their browser to visit a website; depending on the website, the user indicates goods or services they wish to purchase or alternatively, they indicate that they wish to submit payment for services that were incurred in another manner, such as payment of taxes to a taxing authority. As a result of such a transaction, payment is submitted using a credit card (step 505). For purposes of this illustrative example, the entity receiving the payment will be called the vendor.

The vendor provides instructions to the user to take a picture of the credit card and email the resulting picture to an email address provided (step 510), in order to provide proof that the card is in the user's possession. The instructions can also include a unique identifier to be included in the email in order to tie the emailed picture to a specific transaction. It is assumed in this example that this step of taking and emailing a photograph is mandatory for completion of the sale, since the performance of the following steps is the object of the invention. However, it is recognized that vendors currently accept credit cards without such verification and that many persons will not have the capabilities to follow these instructions. Alternatively, the vendor may offer an enticement for the user to follow these steps, such as passing on a portion of the vendor's savings to the user or providing other inducements.

Preferably, the instructions include specific details for the credit card to be held in a specific manner or in a specific location for the photograph, in order to ensure that the photograph is current and not a stored image. The instructions can also include instructions to turn the card over to photograph and send the back side of the credit card. Possibilities for this step will be discussed in greater detail below.

The user then positions the credit card as indicated, takes a digital picture, and emails the resulting photograph (step 515). Mobile phones or personal digital assistants that are equipped with digital cameras have an inherent ability to email the photos to an address entered by the user, so that the user need merely follow the instructions included with their specific device. Alternatively, a regular digital camera can be used to take the picture, with the photograph being subsequently downloaded to the computer and sent as an attachment to an email. A webcam can also be used to capture the image.

Once the vendor receives the photograph, they forward the photograph to the credit-card company (step 520), just as they would any other information about the credit card or user in other circumstances. The credit-card company then runs various algorithms on the photograph to provide validation of the card (step 525). For example, the algorithms can include (a) edge detection algorithms that detect the user name and credit-card numbers on the face of the card, (b) photoshop image manipulation algorithms that can detect tampering of the image, (c) biometric algorithms that can check indicators of a person holding the card, and (d) analysis of the photograph to determine if the directions were followed by the user when taking the photo, thus ensuring that the image is current. These are only a sample of the algorithms that can be run against the photograph; other algorithms can also be added or substituted in the illustrative embodiments.

Once the algorithms are completed, the credit-card company notifies the vendor whether the card is accepted or not (step 530). The vendor will evaluate the answer to determine if the card is accepted (step 535). If the card is not accepted, the order is aborted (step 570) and the method ends. There are, of course, other means of completing the payment transaction, such as the user submitting another credit card or authorizing an electronic funds transfer from a checking account, but these are not within the scope of this invention and will not be discussed further.

If the credit card is accepted, the vendor must still determine if the picture was verified, so that a discount is offered (step 540). If the picture was accepted, a discount or other perk is credited to the customer (step 545), otherwise a message is sent to indicate that the picture is not accepted (step 550). The vendor can then display the status of the order for approval by the customer (step 555). Such a display typically asks the user if they wish to proceed, now that all information has been collected (step 560). If the user wishes to proceed, the order is finalized (step 565) and the process ends.

Alternatively, the user may decide to terminate the transaction for their own reasons and the order is aborted (step 570). Finally, the user may decide to attempt the verification process again with another photo. In this case, the process returns to step 510, where another picture is taken and submitted.

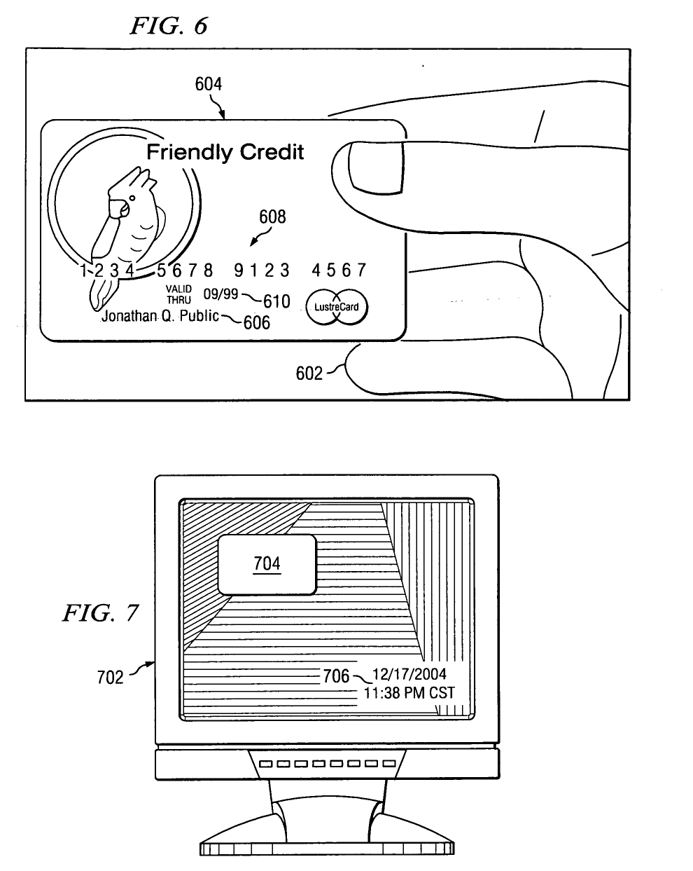

It was noted earlier that the specific instructions for taking the photograph, which the vendor provides in step 510, are intended to ensure that the photograph is current and not a stored image. This aspect will now be discussed further with reference FIG. 6 and FIG. 7.

FIG. 6 discloses a photograph of a hand 602 holding a credit card 604, such as might be taken and submitted during the method of FIG. 5. Such a photo taken by a camera containing three (3) megapixels is sufficient to provide the detail necessary for an embodiment of the invention. Such a photograph allows edge discrimination algorithms to read the user name 606, credit-card number 608, and expiration date 610, all of which are needed by the credit-card company for verification. Having the user's hand 602 in the picture can provide some simple biometric measurements for analysis. Such measurements can include, for example, skin tone, length of fingers, and as the resolution of pictures increases, may even provide the opportunity to check fingerprints.

FIG. 7 discloses another method of ensuring a current picture, according to an illustrative embodiment of the invention. The vendor can provide a unique screen to serve as a background for the photograph. In this photo, monitor screen 702 shows a random screen on which strongly directional lines have been displayed. The screen 702 preferably also includes a blank location 704 where the credit card can be held while being photographed. Although this exemplary screen is very simple, one of ordinary skill in the art would recognize that an infinite number of screens could easily be generated to serve as a background.

Additionally, the screen can contain identifiers, such as date/time stamp 706, or an encoded identifier, such as a complicated barcode. The presentation of a photograph of the credit card taken in front of a unique display can provide strong evidence that the photograph was taken at the time that the screen was provided to the user. Since the vendor, possibly in collaboration with the credit-card company, provides the screen, many options are available for including pertinent information in the photograph, such as the unique transaction identifier. If necessary or desired, vendor 404 can transmit to credit-card company 406 a copy of the screen presented to client 402, for comparison against the photograph.

Thus, the disclosed method, apparatus, and computer instructions provide a means by which a credit-card company can ascertain that a given user is in possession of a card being presented for payment. This mechanism lowers their exposure to fraudulent attempts to use a card and can lower their costs. These savings can be passed on to the vendor to encourage the use of the enclosed method.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of receiving payment using a transaction card, said method comprising the steps of:
receiving a designation that a user desires to make a payment by transaction card;
requesting a photograph of the transaction card in a given setting to be sent electronically to a given location;
on receipt of said photograph, forwarding said photograph, along with a corresponding record of the transaction, to a transaction entity with a request for an indicator of acceptance; and
responsive to receiving a reply to the request, selectively allowing a transaction to complete based on the value of said indicator in said reply.

2. The method of claim 1, wherein said selectively allowing step allows the payment to proceed based on the value of said indicator.

3. The method of claim 1, wherein said selectively allowing step allows a discount or perk to the user based on the value of said indicator.

4. The method of claim 1, wherein said sending step includes providing a unique identifier to the user for return with said photograph.

5. The method of claim 1, wherein said sending step instructs the user to hold the transaction card in a specific manner when taking said photograph.

6. The method of claim 1, wherein said sending step instructs the user to hold the transaction card against a screen provided by the vendor when taking said photograph.

7. The method of claim 6, wherein said screen contains characteristics that can be checked in said photograph for verification of the time said photograph is taken.

8. The method of claim 1, wherein said requesting step requests that said photograph be sent to an email address.

9. A method of validating a transaction card, said method comprising the steps of:
receiving, from a vendor, an electronically transmitted photograph of a transaction card and information regarding a transaction against said transaction card;
performing an algorithm on said photograph to provide information; and
providing an indicator of acceptance or rejection to the vendor, based on the results of said algorithm.

10. The method of claim 9, wherein said providing step provides an acceptance or rejection of the transaction card.

11. The method of claim 9, wherein said providing step provides an acceptance or rejection of a discount.

12. The method of claim 9, wherein said receiving step further receives a copy of a unique screen that was presented to a browser for said photograph.

13. The method of claim 9, wherein said performing step performs an edge-detection algorithm on said photograph.

14. The method of claim 9, wherein said performing step performs a biometric algorithm on a portion of said photograph.

15. The method of claim 9, wherein said performing step performs an image manipulation algorithm on said photograph to detect tampering with said photograph.

16. The method of claim 9, wherein said performing step performs an analysis of the photograph to determine if directions provided by a vendor were followed by the user when taking the photo.

17. The method of claim 16, wherein said photograph is checked against a copy of a screen provided to the browser by the vendor.

18. A computer program product on a computer-readable media, said computer program product comprising:
first instructions for receiving a designation that a user desires to make a payment by transaction card;
second instructions for requesting a photograph of the transaction card in a given setting to be electronically sent to a given location;
third instructions for, on receipt of said photograph, forwarding said photograph, along with a corresponding record of the transaction, to a transaction entity with a request for an indicator of acceptance; and
fourth instructions for selectively allowing a transaction to complete based on the value of said indicator.

19. The computer program product of claim 18, wherein said fourth instructions allows the payment to proceed based on the value of said indicator.

20. The computer program product of claim 18, wherein said fourth instructions allows a discount or perk to the user based on the value of said indicator.

21. The computer program product of claim 18, wherein said second instructions include providing a unique identifier to the user for return with said photograph.

22. The computer program product of claim 18, wherein said second instructions instruct the user to hold the transaction card in a specific manner when taking said photograph.

23. The computer program product of claim 18, wherein said second instructions instruct the user to hold the transaction card against a screen provided by the vendor when taking said photograph.

24. The computer program product of claim 23, wherein said screen contains characteristics that can be checked in said photograph for verification of time said photograph is taken.

25. The computer program of claim 18, wherein said second instructions request that said photograph be sent to an email address.

26. A computer program product on a computer-readable media for validating a transaction card, said method comprising:
first instructions for receiving a photograph of a transaction card and information regarding a transaction against said transaction card;
second instructions for performing an algorithm on said photograph to provide information; and
third instructions for providing an indicator of acceptance or rejection, based on the results of said algorithm.

27. The computer program product of claim 26, wherein said third instructions provide an acceptance or rejection of the transaction card.

28. The computer program product of claim 26, wherein said third instructions provide an acceptance or rejection of a discount.

29. The computer program product of claim 26, wherein said first instructions further receive a copy of a unique screen that was presented to a browser for said photograph.

30. The computer program product of claim 26, wherein said second instructions perform an edge-detection algorithm on said photograph.

31. The computer program product of claim 26, wherein said second instructions perform a biometric algorithm on a portion of said photograph.

32. The computer-program product of claim 26, wherein said performing step performs an image manipulation algorithm on said photograph to detect tampering with said photograph.

33. The computer program product of claim 26, wherein said performing step performs an analysis of the photograph to determine if directions provided by a vendor were followed by the user when taking the photo.

34. The computer program product of claim 33, wherein said photograph is checked against a copy of a screen.

35. A method of receiving payment using a transaction card, said method comprising:
receiving electronically, from a user utilizing the transaction card for payment, a photograph of the transaction card in a specified setting;
verifying said photograph of the transaction card in said specified setting for authenticity with the user;
authorizing a use of the card for the payment if verified.

36. The method of claim 35, wherein said verifying step performs at least one of the following algorithms on said photograph: an edge-detection algorithm, a biometric algorithm, an image manipulation algorithm, and an analysis of the photograph to determine if directions provided by a vendor were followed by the user when taking the photo.

37. A computer program product on a computer-readable media, said computer program product comprising:
first instructions for receiving electronically, from a user utilizing the transaction card for payment, a photograph of the transaction card in a specified setting;
second instructions for verifying said photograph of the transaction card in said specified setting for authenticity with the user;
third instructions for authorizing a use of the card for the payment if verified.

38. The method of claim 37, wherein said second instructions perform at least one of the following algorithms on said photograph: an edge-detection algorithm, a biometric algorithm, an image manipulation algorithm, and an analysis of the photograph to determine if directions provided by a vendor were followed by the user when taking the photo.

39. A computer system, comprising:
a processor connected to send and receive communications over the Internet; and
a computer program stored in computer-readable memory that is accessible to be executed by said processor, said computer program containing
first instructions for receiving electronically, from a user utilizing the transaction card for payment, a photograph of the transaction card in a specified setting;
second instructions for verifying said photograph of the transaction card in said specified setting for authenticity with the user;
third instructions for authorizing a use of the card for the payment if verified.

40. The computer system of claim 39, wherein said second instructions perform at least one of the following algorithms on said photograph: an edge-detection algorithm, a biometric algorithm, an image manipulation algorithm, and an analysis of the photograph to determine if directions provided by a vendor were followed by the user when taking the photo.
